(19) United States
(12) Patent Application Publication
(10) Pub. No.: US 2023/0043002 A1
(43) Pub. Date: Feb. 9, 2023

(54) Multi Hex Bit Driver Adjustable System

(71) Applicant: Vincent Reese Long, San Leandro, CA (US)

(72) Inventor: Vincent Reese Long, San Leandro, CA (US)

(21) Appl. No.: 17/877,409

(22) Filed: Jul. 29, 2022

Related U.S. Application Data
(63) Continuation-in-part of application No. 29/804,200, filed on Aug. 18, 2021.
(60) Provisional application No. 63/229,667, filed on Aug. 5, 2021.

(51) Int. Cl. B25B 21/00; B25B 23/00

(52) U.S. Cl. CPC B25B 21/002; B25B 23/0035

(57) ABSTRACT

A multi-bit driver apparatus containing a driver housing, a plurality of rotary drivers, and a rotary driver mechanism is presented. The driver housing contains a driver receiving cavity, and a plurality of rotary apertures. The plurality of rotary each contains a bit shaft, and a bit mounting aperture. The driver receiving cavity is positioned within the driver housing. The plurality of rotary apertures is distributed about the driver housing. The plurality of rotary drivers is positioned within the driver receiving cavity. The bit shaft is rotatably connected along the plurality of rotary apertures. The plurality of rotary drivers is rotatably engaged to each other through the rotary driver mechanism, where the plurality of rotary drivers is configured to rotate in tandem with each other. The bit mounting aperture traverses through the bit shaft.

### FIELD OF THE INVENTION

The present invention relates to drill tools. More specifically, the present invention is an adjustable system that provide the ability to simultaneously drill, screw, unscrew, etc. multiple area/points at a given time.

### BACKGROUND OF THE INVENTION

The usage of power equipment and tools is by far one of the most efficient ways for the construction of objects, places, or the like. Power equipment and tools, such as a hand-held drill or power drill, are extremely efficient for construction purposes. For instance, hand-held drills/power drills are extremely swift when it comes to drilling holes, dealing with a type of fastener, or of the like. It is a frequent occurrence that a hand-held drill or power drill will be utilized to deal with multiple holes or fastening points. When it comes to dealing with multiple holes or fastening points, a standard hand-held drill or power drill will be able to interact with a singular hole and/or fastening point at a time. Thus, it can be time consuming when dealing with a particular project with numerous holes and/or fastening points.

An objective of the present invention is to provide a device that allows simultaneous interaction with multiple holes and/or fastening points at a given moment. The present invention is an accessory for hand-held drills, power drills, or the like to assist with the interaction of multiple holes/fastening points. Furthermore, the present invention is a device that is able to attach together as a system to allow the user to configure into different drill bit positions.

### SUMMARY OF THE INVENTION

The present invention is a multi-bit driver apparatus suited for driving multiple fastener implements. The multi-bit driver apparatus comprises a driver housing, a plurality of rotary drivers, and a rotary driver mechanism. The driver housing comprises a driver receiving cavity, and a plurality of rotary apertures. The plurality of rotary drivers each comprises a bit shaft, and a bit mounting aperture.

In the preferred embodiment, the driver receiving cavity is positioned within the driver housing. The plurality of rotary apertures is distributed about the driver housing. In the preferred embodiment, the plurality of rotary apertures is linearly dispersed, but may be distributed in any other orientation. The plurality of rotary drivers is positioned within the driver receiving cavity. The bit shaft is rotatably connected along the plurality of rotary apertures such that the bit shaft is guided and secured along the plurality of rotary apertures. The plurality of rotary drivers is rotatably engaged to each other through the rotary driver mechanism, where the plurality of rotary drivers is configured to rotate in tandem with each other. In the preferred embodiment, the plurality of rotary drivers and the rotary driver mechanism may take the form of a sprocket-chain drive mechanism. In another embodiment, the plurality of rotary drivers and the rotary driver mechanism may take the form of a gear driven drive mechanism. The bit mounting aperture traverses through the bit shaft such that conventional tool bit shafts may traverse through the bit shaft.

### BRIEF DESCRIPTION OF THE DRAWINGS

FIG. 1 is a top perspective view of the present invention.

FIG. 2 is a bottom perspective view of the present invention.

FIG. 3 is a top perspective exploded view of the present invention.

FIG. 4 is a bottom perspective exploded view of the present invention.

FIG. 5 is a top perspective view of the present invention connected along a drill in a combined configuration.

FIG. 6 is a top perspective view of the present invention in accordance with the combined configuration.

FIG. 7 an exploded view of the present invention in accordance with the combined configuration.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

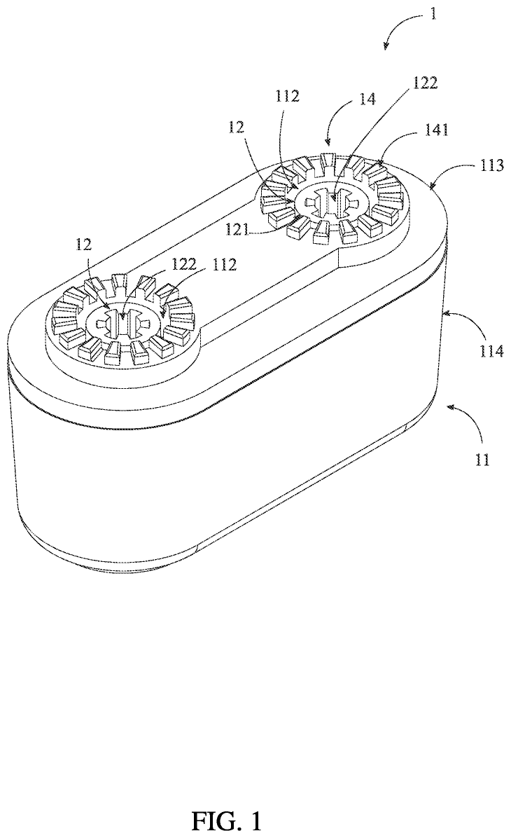

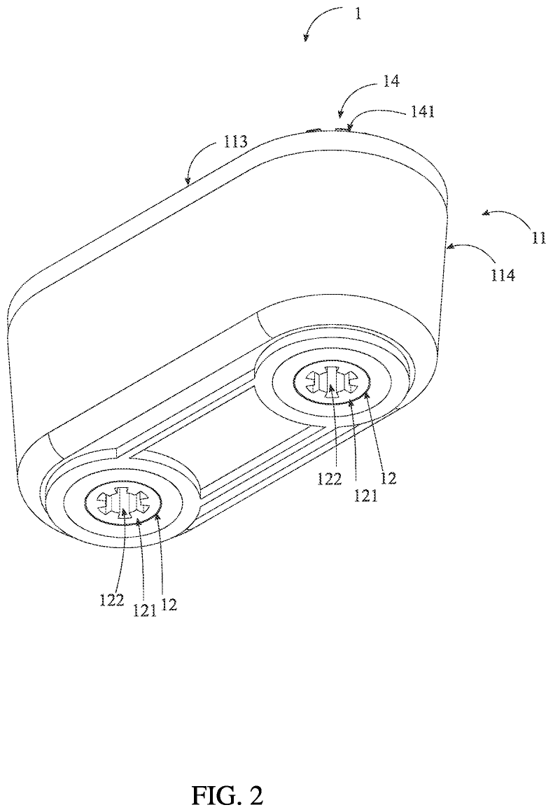

In reference to FIGS. 1-7, the present invention is a multi-bit driver apparatus 1 suited for driving multiple fastener implements. The multi-bit driver apparatus 1 comprises a driver housing 11, a plurality of rotary drivers 12, and a rotary driver mechanism 13. The driver housing 11 comprises a driver receiving cavity 111, and a plurality of rotary apertures 112. The plurality of rotary drivers 12 each comprises a bit shaft 121, and a bit mounting aperture 122. In the preferred embodiment, the driver housing 11 takes the form of the main body of the multi-bit driver apparatus 1 that houses and secures the components the constitutes the multi-bit driver apparatus 1. In the preferred embodiment, the driver housing 11 is made out of any suitable material that is durable, lightweight, and economical, such as, but not limited to high strength polymer composites, aluminum, steel, or any other suitable material. In the preferred embodiment, the plurality of rotary drivers 12 takes the form of any suitable bit driving implement that mounts and secures conventional tool driver bits. In the preferred embodiment, the rotary driver mechanism 13 takes the form of any suitable rotary mechanism that rotatably links and synchronize the plurality of rotary drivers 12 together along the housing. In various embodiments, the rotary driver mechanism 13 may take the form of chain drive mechanisms, gear driven mechanisms, or any other suitable rotary driver mechanism 13. In the preferred embodiment, the drive receiving cavity takes the form of a receiving cavity with sufficient clearance to house the plurality of rotary drivers 12 and the rotary driver mechanism 13 within the driver housing 11. In the preferred embodiment, the plurality of rotary apertures 112 takes the form of rotary aperture implements bored to appropriate size to rotatably connect the plurality of rotary drives along the driver housing 11. In the preferred embodiment, the bit shaft 121 takes the form of a cylindrical shaft body that rotates along the plurality of rotary apertures 112. The bit shaft 121 serves as the main body to support the bit mounting aperture 122. In the preferred embodiment, the bit mounting aperture 122 takes the form of any suitable mounting aperture for mounting and holding a conventional screw bit holder. Such mounting apertures may include, but are not limited to hexagonal shaped apertures, star shaped apertures, or any other suitable shape. In the preferred embodiment, the bit mounting aperture 122 is a hexagonal bit receiving aperture.

In the preferred embodiment, the driver receiving cavity 111 is positioned within the driver housing 11. The plurality of rotary apertures 112 is distributed about the driver housing 11. In the preferred embodiment, the plurality of rotary apertures 112 is linearly dispersed, but may be distributed in any other orientation. The plurality of rotary drivers 12 is positioned within the driver receiving cavity 111. The bit shaft 121 is rotatably connected along the plurality of rotary apertures 112 such that the bit shaft 121 is guided and secured along the plurality of rotary apertures 112. The plurality of rotary drivers 12 is rotatably engaged to each other through the rotary driver mechanism 13, where the plurality of rotary drivers 12 is configured to rotate in tandem with each other. In the preferred embodiment, the plurality of rotary drivers 12 and the rotary driver mechanism 13 may take the form of a sprocket-chain drive mechanism. In another embodiment, the plurality of rotary drivers 12 and the rotary driver mechanism 13 may take the form of a gear driven drive mechanism. The bit mounting aperture 122 traverses through the bit shaft 121 such that conventional tool bit shaft 121s may traverse through the bit shaft 121.

In reference to FIGS. 1-3, the driver housing 11 further comprises a plate housing 113 and a driver chassis 114. In the preferred embodiment, the plate housing 113 takes the form of a cover plate that secures the internal components that resides in the driver chassis 114. The driver chassis 114 serves as the housing element of the driver housing 11 that secures and holds the plurality of rotary drivers 12 and the rotary driver mechanism 13. The driver receiving cavity 111 traverses into the driver chassis 114. The plurality of rotary apertures 112 traverses from the plate housing 113 to the driver chassis 114. The plate housing 113 is connected adjacent to the driver receiving cavity 111.

In reference to FIGS. 1-3 and 7, the multi-bit driver apparatus 1 further comprises a plurality of adjustment elements 14. The plurality of adjustment elements 14 is positioned outside of the driver housing 11. The plurality of adjustment elements 14 is connected along the plurality of rotary apertures 112, where the plurality of adjustment elements 14 is configured to adjust interconnected multi-bit driver apparatus' 1 in a specified angle in a combined configuration. The plurality of adjustment elements 14 takes the form of any suitable adjustment element that facilitates the interconnection of two or more multi-bit driver apparatus' 1. Additionally, the plurality of adjustment elements 14 provides a means of adjusted the interconnected multi-bit driver apparatus' 1 to any angular orientation. More specifically, the adjustment element comprises a plurality of connection tabs 141. The plurality of connection tabs 141 is radially distributed along the plurality of rotary apertures 112, where the plurality of connection tabs 141 of interconnected multi-bit driver apparatus' 1 is configured to enmesh together in the combined configuration. The plurality of connection tabs 141 serves as shear securement members along the interconnected multi-bit driver appartus'.

In the preferred embodiment, the plurality of adjustment elements 14 is positioned outside of the plate housing 113. The plurality of adjustment elements 14 is connected along the plurality of rotary apertures 112, where the plurality of adjustment elements 14 is configured to adjust interconnected multi-bit driver apparatus' 1 in a specified angle in the combined configuration such that the interconnected multi-bit driver apparatus' 1 are connected along the plate housing 113 side. The plurality of connection tabs 141 is radially distributed along the plurality of rotary apertures 112, where the plurality of connection tabs 141 of interconnected multi-bit drivers is configured to enmesh together in the combined configuration such that the interconnected multi-bit driver apparatus' 1 are connected along the plate housing 113 side.

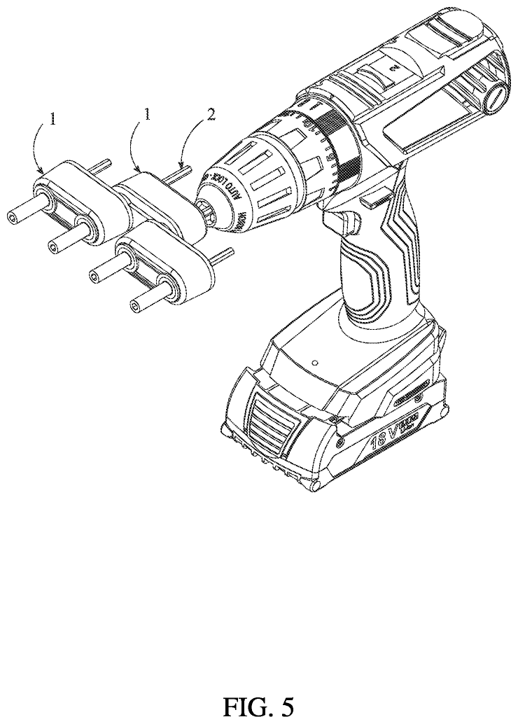

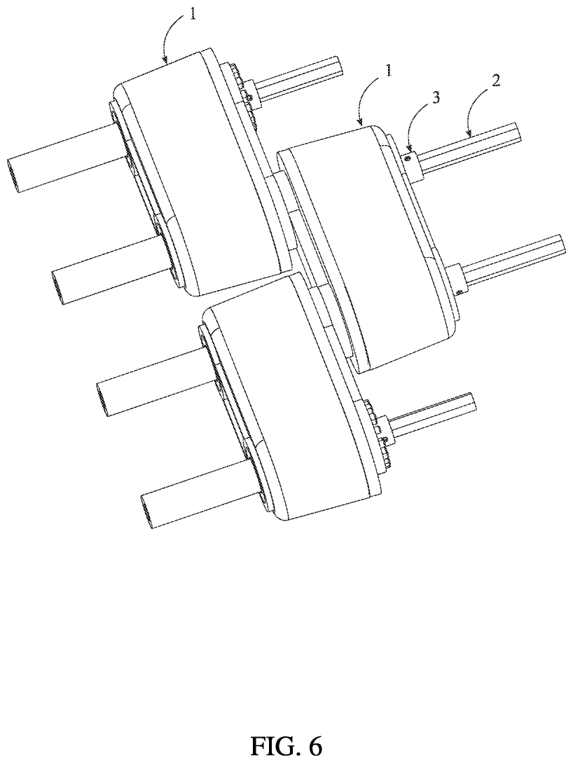

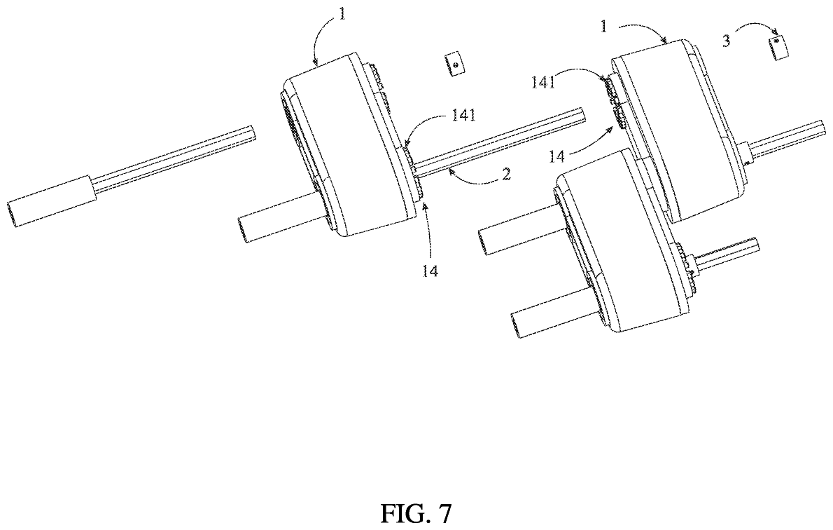

In the preferred embodiment, the multi-bit driver apparatus 1 is configured to interconnect with one or more multi-bit driver apparatus' 1 by utilizing a plurality of conventional tool bit implements 2 and connection sleeves 3, as shown in FIGS. 6-7. In the combined configuration, the one or more multi-bit driver apparatus' 1 are connected together by enmeshing the plurality of connection tabs 141 of the multi-bit driver apparatus' 1. The conventional tool bit implement 2 is then inserted through the bit mounting aperture 122, where the connection sleeve 3 is secured along the bit mounting aperture 122 such that interconnected multi-bit apparatus' are fixed together along the conventional tool bit element, as shown in FIG. 5-6.

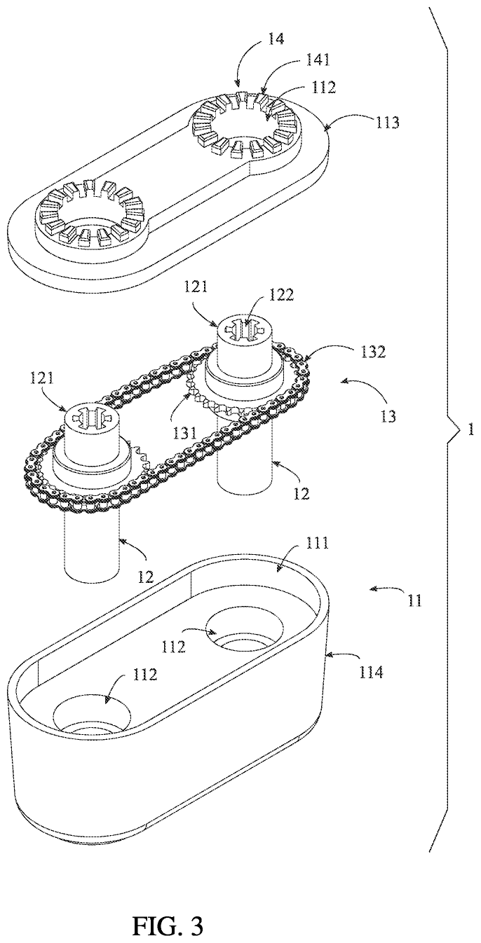

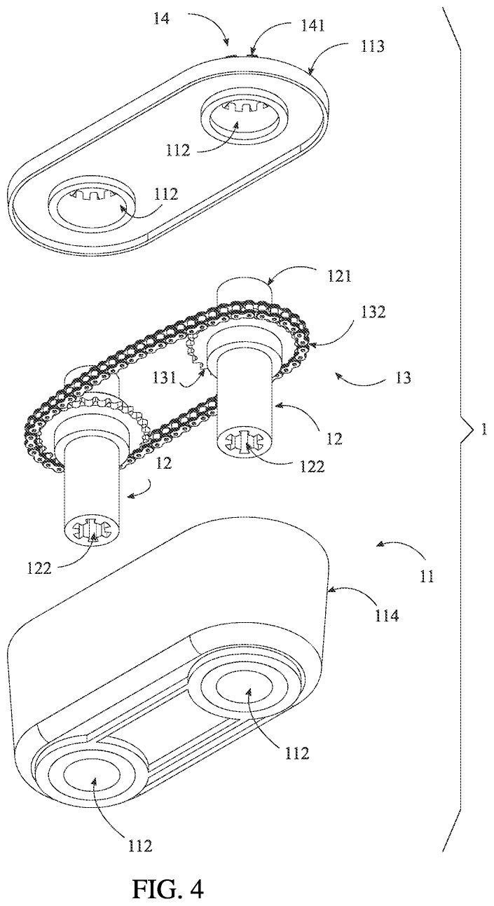

In the preferred embodiment, the rotary driver mechanism 13 comprises a plurality of drive sprockets 131 and a drive chain 132, as shown in FIGS. 3-4. The plurality of drive sprockets 131 and the drive chain 132 takes the form of a chain-drive mechanism. The plurality of drive sprockets 131 is torsionally connected to the plurality of rotary drivers 12. The plurality of drive sprockets 131 is torsionally engaged to each other through the drive chain 132, where the plurality of rotary drivers 12 is configured to rotate in tandem with each other.

Although the invention has been explained in relation to its preferred embodiment, it is to be understood that many other possible modifications and variations can be made without departing from the spirit and scope of the invention as hereinafter claimed.

What is claimed is:

1. A multi-bit driver apparatus comprising:
a driver housing;
a plurality of rotary drivers;
a rotary driver mechanism;
the driver housing comprising a driver receiving cavity, and a plurality of rotary apertures;
the plurality of rotary drivers each comprising a bit shaft, and a bit mounting aperture;
the driver receiving cavity being positioned within the driver housing;
the plurality of rotary apertures being distributed about the driver housing;
the plurality of rotary drivers being positioned within the driver receiving cavity;
the bit shaft being rotatably connected along the plurality of rotary apertures;
the plurality of rotary drivers being rotatably engaged to each other through the rotary driver mechanism, wherein the plurality of rotary drivers is configured to rotate in tandem with each other; and
the bit mounting aperture traversing through the bit shaft.

2. The multi-bit driver apparatus as claimed in claim 1 comprising:
the driver housing further comprising a plate housing and a driver chassis;
the driver receiving cavity traversing into the driver chassis;
the plurality of rotary apertures traversing from the plate housing to the driver chassis; and
the plate housing being connected adjacent to the driver receiving cavity.

3. The multi-bit driver apparatus as claimed in claim 1 comprising:
a plurality of adjustment elements;
the plurality of adjustment elements being positioned outside of the driver housing; and
the plurality of adjustment elements being connected along the plurality of rotary apertures, wherein the plurality of adjustment elements is configured to adjust interconnected multi-bit drivers in a specified angle in a combined configuration.

4. The multi-bit driver apparatus as claimed in claim 3 comprising:
the adjustment element comprising a plurality of connection tabs;
the plurality of connection tabs being radially distributed along the plurality of rotary apertures, wherein the plurality of connection tabs of interconnected multi-bit drivers is configured to enmesh together in the combined configuration.

5. The multi-bit driver apparatus as claimed in claim 2 comprising:
a plurality of adjustment elements;
the plurality of adjustment elements being positioned outside of the plate housing; and
the plurality of adjustment elements being connected along the plurality of rotary apertures, wherein the plurality of adjustment elements is configured to adjust interconnected multi-bit drivers in a specified angle in the combined configuration.

6. The multi-bit driver apparatus as claimed in claim 5 comprising:
the adjustment element comprising a plurality of connection tabs;
the plurality of connection tabs being radially distributed along the plurality of rotary apertures, wherein the plurality of connection tabs of interconnected multi-bit drivers is configured to enmesh together in the combined configuration.

7. The multi-bit driver apparatus as claimed in claim 1, comprising:
the rotary driver mechanism comprising a plurality of drive sprockets and a drive chain;
the plurality of drive sprockets being torsionally connected to the plurality of rotary drivers; and
the plurality of drive sprockets being torsionally engaged to each other through the drive chain, wherein the plurality of rotary drivers is configured to rotate in tandem with each other.

8. The multi-bit driver apparatus as claimed in claim 1, wherein the bit mounting aperture is a hexagonal bit receiving aperture.
